(19) United States
(12) Patent Application Publication
(10) Pub. No.: US 2017/0003160 A1
(43) Pub. Date: Jan. 5, 2017

(54) MARINE ANIMAL DATA CAPTURE AND AGGREGATION DEVICE

(71) Applicant: SMART CATCH LLC, Palo Alto, CA (US)

(72) Inventors: ROBERT MARK TERRY, PALO ALTO, CA (US); JAKOB CLARK SCHELL, OAKLAND, CA (US)

(21) Appl. No.: 15/201,541

(22) Filed: Jul. 4, 2016

Related U.S. Application Data
(60) Provisional application No. 62/188,603, filed on Jul. 3, 2015.

(51) Int. Cl. G01G 19/52; G01G 23/35; G06K 9/00

(52) U.S. Cl. CPC G01G 19/52; G06K 9/00362; G01G 23/35

(57) ABSTRACT

Disclosed is an apparatus incorporating a data capture method involving capturing an image and weighing marine animals during or after harvest. Data captured may be compared against a set of preconfigured rules, the results of which may aid in optimizing a fisherman's workflow by alerting the fisherman of the presence of characteristics of the marine animals that violate any of the set of preconfigured rules, such as bycatch, endangered, or breeding animals. As such, the apparatus may improve operational efficiency, reduce overhead costs, promote transparent fishing practices, and provide catch-to-plate data to various stakeholders. The apparatus also enables an economic model that incentivizes fishermen to use the apparatus by facilitating the remittance of micropayments in exchange for data captured through the apparatus. The apparatus offers a consistent, reliable means of collecting and aggregating complete data from marine animals while at the same time aiding fishermen compliance with regulations.

### CLAIM OF PRIORITY

This application claims priority to U.S. Provisional Patent Application Ser. No. 62/188,603, filed Jul. 3, 2015, the entire disclosure of which is hereby expressly incorporated by reference herein.

### FIELD OF TECHNOLOGY

This disclosure relates generally to data processing devices and, more particularly, to a method, a device and/or a system of capturing data associated with marine animals during harvesting.

### BACKGROUND

Sustainable seafood harvesting requires proper accountability, from the catch to the plate. The accounting process involves counting, sorting, inspection, determination of size and gender, and various other activities that must be performed in order to meet industry and/or compliance standards. Currently, these activities are largely performed by fishermen. However, this system is highly prone to error and since fishermen's work-flow is disrupted by lengthy inspections and accounting, these activities are sometimes curtailed to increase operating efficiency. Geospatial origin is another factor in seafood harvesting accountability—harvesting fish from breeding grounds contributes to the extinction of entire species. Seafood harvesting in sustainable areas only is not only encouraged, but required by the governments of many countries worldwide. However, current systems that account for geospatial origin are inconsistent or nonexistent. Especially during crab harvesting, fishermen counting harvested crabs must determine not only size and gender but also whether the crabs are carrying eggs. This approach is highly prone to errors as well as to arbitrary and inconsistent determinations. Additionally, there is currently no system in place to incentivize fishermen to improve their accountability. Without such a system, businesses that rely on fishermen to conduct proper inspections suffer due to the overwhelming consumer demand for proof of sustainable practices. Especially for multi-species fish harvesting, fish must be sorted by species, size, and/or shape in order to meet sustainable guidelines. Since most of these guidelines only apply to processing plants and distributors further down the supply chain, harvesting accountability is largely ignored by fishermen, who are more concerned with improving operating efficiency by reducing time and fuel spent while sorting. As such, there is no system in place that incentivizes fishermen to regularly collect complete data for their harvests at the time of origination.

Thus, there exists a need for a turn-key system that facilitates accountability of marine animal data capture.

### SUMMARY

In one aspect, an apparatus comprises a processor, a memory, and one or more sensors. The processor is configured to execute a set of instructions stored in the memory. The set of instructions cause the apparatus to perform a data capture session. During the data capture session, the apparatus detects a weight differential through the one or more sensors. The apparatus also measures, upon detecting the weight differential, a weight and captures an image through the one or more sensors. Based on the captured image, the apparatus compares one or more characteristics derived from the image or the weight to one or more preconfigured rules of the processor.

In another aspect, a method of a data capture session through an apparatus comprises detecting, through a processor of the apparatus, a weight differential through one or more sensors communicatively coupled to the processor. The method also comprises measuring a weight and capturing an image through the one or more sensors. The method further comprises comparing one or more characteristics derived from the image or the weight to one or more preconfigured rules of the processor.

In yet another aspect, a method of initiating a data capture session of an apparatus comprises detecting, through a processor, a presence of a custom card, wherein the custom card comprises a user identifier and one or more weights. The method also comprises retrieving the user identifier from the custom card. The method further comprises validating the user identifier against a whitelist of user identifiers. The method additionally comprises calibrating at least one of the one or more sensors through the one or more weights. The method also comprises generating a session identifier associated with the data capture session. The method further comprises associating the user identifier with the session identifier.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a component view of the marine animal data capture and aggregation device, according to one or more embodiments.

FIG. 2 is a block diagram illustrating the marine animal data capture and aggregation device of FIG. 1 as a client communicating with a server through a network, according to one or more embodiments.

FIG. 3A is a front perspective view of the marine animal data capture and aggregation device of FIG. 1, according to one or more embodiments.

FIG. 3B is a perspective view showing operation of the bottomless drawer of the marine animal data capture and aggregation device of FIG. 1, according to one or more embodiments.

FIG. 3C is a rear perspective view of the marine animal data capture and aggregation device of FIG. 1, according to one or more embodiments.

FIG. 4 is a decision flow chart illustrating a data capture method of the marine animal data capture and aggregation device of FIG. 1, according to one or more embodiments.

FIG. 5 is a schematic diagram of a custom card used for session initiation and calibration by the marine animal data capture and aggregation device of FIG. 1, according to one or more embodiments.

FIG. 6 is a data hierarchy showing relationships between identifiers utilized during aggregation of data captured through the marine animal data capture and aggregation device of FIG. 1, according to one or more embodiments.

FIG. 7 is a decision flow chart illustrating a session initiation process using the custom card of FIG. 5, according to one or more embodiments.

FIG. 8 is a schematic of a tank having one or more chambers, according to one or more embodiments.

FIG. 9 is a schematic showing a tank coupled to the marine animal data capture and aggregation device of FIG. 1, according to one or more embodiments.

Other features of the present embodiments will be apparent from the accompanying drawings and from the detailed description that follows.

### REFERENCE LIST FOR DRAWINGS

100—marine animal data capture and aggregation device

102—processor

104—memory

106—co-processor

108—load cell

110—camera array

112—analysis module

114—LED array

116—motion detection module

118—I/O interface

120—speaker

122—display screen

124—mating flange

126—power source

128—manifold

200—server

202—network

300—slide

302—waterproof container

304—first opening

306—second opening

308—flotation chambers

310—handles

312—legs

314—waterproof container

316—arrow

318—bottomless drawer

320—solar panel

400—data capture method

402—pre-trigger phase

404—trigger phase

406—analysis phase

408—action phase

410—standby mode

412, 414, 416, 420, 422—processes

500—custom card

502—user identifier

504—one or more weights

600—data hierarchy

602—load identifier

604—load

606—session identifier

608—data capture session

610—user identifier

612—user

614—owner identifier

616—animal identifier

618—biomass unit

700—session initiation process

702-710—processes

800—tank

802—holding chamber

804—first drain

806—staging area

808—second drain

810—identification (ID) chamber

812—third drain

814—spiral ramp

900—tank

902—marine animal data capture and aggregation device

### DETAILED DESCRIPTION

Example embodiments, as described below, may be used to provide a method, a device and/or a system for capturing data associated with marine animal harvesting.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Elements described herein as coupled may have a direct or indirect connection with one or more other intervening elements.

Definitions

“Module” refers to any element that may be embodied in software or hardware.

“Analysis” or “analysis procedure” refers to a process of checking one or more parameters against one or more rules.

“Enumeration” refers not only to the process of counting, but also sorting and data capture.

“Harvest” refers to a load captured by a fishery in a wild catch or aquaculture setting.

“Data capture” refers to the collection and/or aggregation of data.

“Data processing device” refers to any device having a processor configured to execute instructions stored in memory. A data processing device may comprise any number of input and/or output devices, including peripheral devices and network interface cards.

“Molting” refers to the regeneration of a crab's shell; in this condition, a crab has low marketability.

“Parameters” refers to one or more particular features of an object.

“Instructions” refers to particular segments of machine-readable code that correspond to a particular function of an application.

“Run” or “execute” refers to the action of a processor with respect to machine-readable code.

“Bycatch” or “non-target species” refer to animals that if caught, may negatively affect the environment and may be the protected target of a state or federal regulation.

“Regulation” refers to a condition imposed on market participants by a government or oversight entity.

“Season” refers to a period of time during which certain fishing activity occurs

“Data capture session” refers to period of time during which data is captured.

“Load identifier” refers to a data element identifying a particular shipment.

“Characteristic” refers to any physical or behavioral feature, especially of an animal.

The ocean environment and the fishing industry are ready for solutions to overfishing and systems that facilitate accountability and sustainability. Disclosed are one or more embodiments of an electromechanical device (hereinafter marine animal data capture and aggregation device or MADCAD) purposed primarily for generating data during a harvest. MADCAD may require little input from fishermen, integrate into and facilitate fishermen workflow, increase efficiency, optimize data gathering, and enable and incentivize sustainable fishing practices. By removing arbitrariness from the data collection process, data integrity is increased while fishermen gain the ability to focus their energies on optimizing the rest of their workflow. In addition, fishermen may use the data to ensure consistent catch results by comparing gathered data with respect to location. To further compliance with regulations, fishermen may also prevent bycatch by staying away from known breeding grounds publicized through the MADCAD. The above are just a few examples of how the MADCAD may provide valuable utility to the fishing industry.

The MADCAD may also integrate seamlessly with a monitoring system for fishing environments as disclosed in U.S. Patent Application Publication No. 2015/0156998 and a load distribution and consolidation tracking system as disclosed in U.S. patent application Ser. No. 14/735,799, the entire text and drawings of which are incorporated herein by reference.

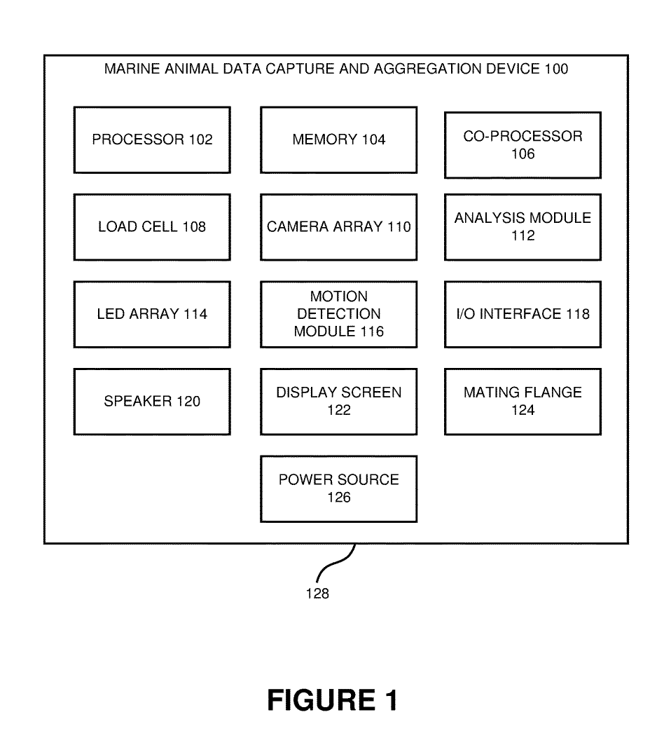

Reference is now made to FIG. 1, which illustrates a component view of a marine animal data capture and aggregation device (MADCAD) 100, according to one or more embodiments. In one embodiment, the MADCAD 100 is a mobile, waterproof (in accordance with NEMA or other standard) unit wherein a marine animal (e.g. crab, lobster, shellfish, fish) may be deposited. Through a microcontroller, one or more sensors and one or more modules, the MADCAD 100 may capture data related to any number of physical characteristics of the marine animals, such as species, weight, gender, presence of eggs, and other information. The information to be gathered may be expanded and may be changed based on the applicable regulations or the business interests in the current harvesting operation.

The MADCAD 100 may comprise a manifold 128 physically configured to house the sensors and modules. In one embodiment, the MADCAD 100 may comprise a processor 102 (CPU and/or GPU) for executing instructions and a memory 104 (volatile and/or non-volatile) for storing data. The processor 102 and the memory 104 may be disposed within a microcontroller (e.g. an Arduino™, a Raspberry Pi™, an ASIC, a PLC, etc.) or a data processing device such as a thin client device (a smartphone, tablet, personal data assistant (PDA), etc.) or a rich client device (laptop, desktop, notebook, etc.). In any case, the processor 102 and memory 104 may be coupled to one or more sensors or modules. In another embodiment, the MADCAD 100 may additionally comprise one or more co-processors 106, which may be dedicated to any subset of sensors or modules.

The MADCAD 100 may comprise a load cell 108, which is a sensor that may detect a weight differential and measure the weight of any object or animal placed on the load cell 108. The load cell 108 may comprise a glass or non-distortion acrylic surface and as such may be suitable for capturing images of objects or animals placed upon the load cell 108. In addition to measuring weight, the MADCAD 100 may capture images through a camera array 110. The camera array 110 may comprise one or more cameras which may be positioned anywhere throughout the MADCAD 100. In one embodiment, a plurality of cameras may be positioned to provide full coverage of the deposited marine animal. In another embodiment, the camera array 110 may comprise one or more cameras and one or more mirrors (i.e. a mirror array) positioned throughout the MADCAD 100 so as to capture multiple angles of the deposited marine animal.

To maintain consistency in environmental light conditions within the MADCAD 100, an LED array 114 may be utilized in concert with the camera array 110 to provide suitable environmental conditions for efficiently utilizing an analysis module 112. The LED array 114 may be used separately as a signal to communicate any subset of alerts, notifications, system settings, etc. For example, the LED array 114 may be used to alert an attendant of a jam in any of the components of the MADCAD 100. The LED array 114 may additionally comprise or be communicatively coupled to a light sensor (not shown) to detect ambient light conditions and adjust the intensity of the LED array 114 accordingly or to detect whether the LED array 114 is functional.

The MADCAD 100 may comprise a motion detection module 116—another sensor that may detect motion, for example, the motion of a marine animal placed on the load cell 108. Upon detecting motion, the motion detection module 116 may be configured to subsequently initialize, through the processor 102, one or more other sensors and/or modules of the MADCAD 100. Though either or both of the load cell 108 and the motion detection module 116 may be used to trigger other sensors and/or modules of the MADCAD 100, the load cell 108 may be preferable due to its ease of calibration, and ability to detect weight differentials as well as measure weight.

Using the image data captured by the camera array 110 and/or the weight measurement provided by the load cell 108, an analysis module 112 may be configured to perform one or more analysis procedures, depending on one or more parameters. The one or more parameters may comprise pre-configured instructions (e.g. run for every marine animal processed through the MADCAD 100) or may be species-dependent (e.g. run procedure X if blue swimmer crab is detected), weight-dependent, gender-dependent, or any other parameter that may be needed for a particular harvesting session. In one embodiment, a gender analysis procedure may be initialized by default to determine the gender of the sliding marine animal. In another embodiment, a breeding analysis procedure may be initialized if blue swimmer crab is detected and the gender of the blue swimmer crab is determined to be female. In yet another embodiment, a bycatch analysis procedure may first classify bycatch by species and enumerate the bycatch. Other procedures may be initialized by the MADCAD 100 and may provide insight into any aspect of the deposited marine animal, and are thus within the scope of the exemplary embodiments described herein. Especially in the case of regulations, which can change based on the season and/or location, and which bycatch (endangered, out of season) species are most at-risk, multiple and separate analysis procedures may be initialized by the MADCAD 100 and may thus allow the MADCAD 100 to more easily integrate into the harvesting workflow for any type of marine animal in any condition or location.

The MADCAD 100 may be more readily integrated into a fisherman's workflow by aiding in the time-intensive decision-making that every harvest requires. For example, a new haul of seafood may contain any number of species of marine animal (target species or bycatch) or may contain non-relevant material (e.g. debris from the seafloor, plastic, etc.). An enumeration process that necessarily involves encoded logic to manipulate said enumeration process may be performed by the MADCAD 100. To at least facilitate notifications to fishermen, the MADCAD 100 may additionally comprise a speaker 120 that may sound an alert to an operator of the MADCAD 100 if any results generated by the MADCAD 100 match one or more pre-configured parameters for an alert. The speaker 120 may be communicatively coupled to a preamplifier and an amplifier. Separate alerts may be played back through the speaker 120 to signal the completion of a stage of the data capture process. Alternately, the alert may be displayed through a display screen 122 of the MADCAD 100. The display screen 122 may enable touchscreen control (with or without multi-touch) and may be accompanied by one or more buttons for scrolling or engaging with the processor 102. Alternately, the alert may be displayed as a pattern communicated to the LED array 114 by the processor 102. Different patterns for the LED array 114 that indicate different alerts may be stored in an alerts library stored in the memory 104.

In one embodiment, the MADCAD 100 may comprise one or more quality control modules which may perform any number of processes for ensuring reliable sorting and data capture. In one embodiment, the MADCAD 100 may comprise a DNA sampling kit which may retrieve a DNA sample from a deposited marine animal that may be communicated as data pertaining to the animal. In another embodiment, the MADCAD 100 may comprise a disease detection unit which may provide insight into a deposited animal's potential diseases (e.g. sea lice).

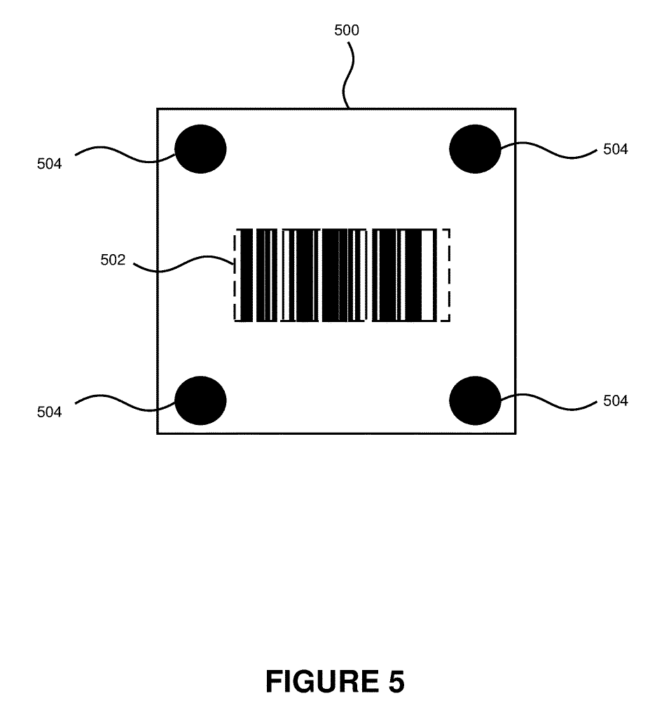

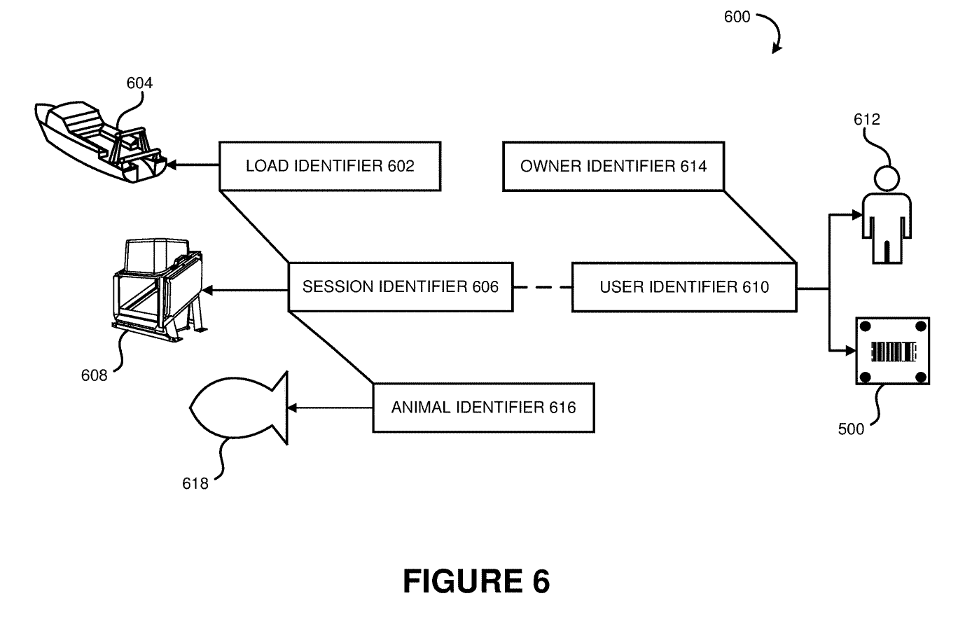

In addition to handling and communicating sorting tasks, the MADCAD 100 may also ease the process of user registration, session initiation, and calibration by providing a method, as shown in FIG. 6, of scanning and weighing a custom card 500 shown in FIG. 5.

Beyond data capture, the MADCAD 100 may play a role in sorting of marine animals or diversion of a portion of a catch through one or more electromechanical components incorporated within the MADCAD 100 or communicatively coupled to the MADCAD 100. To couple further devices to the MADCAD 100 and to facilitate a direct or indirect connection to the components (especially the processor 102 or the power source 126), the manifold 124 of the MADCAD 100 may comprise one or more mating flanges 124. The mating flanges 124 may comprise one or more switch and actuator pairs disposed in such a way that the mating flange 124 may match the corresponding switch-actuator pairs of another mating flange.

In one embodiment, the mating flange 124 may be purely mechanical and may simply allow the physical attachment of further devices/modules. In another embodiment, the mating flange 124 may be an electromechanical aspect of the MADCAD 100 that may allow bi-directional communication between the MADCAD 100 and other devices/modules attached to the MADCAD 100 through the mating flange 124. In another embodiment, the MADCAD 100 may incorporate a software API that may allow support for software or hardware utilized by any devices/modules attached to the MADCAD 100 through the mating flange 124.

The MADCAD 100 may further comprise an input/output (I/O) interface 118. The I/O interface 118 may represent any number of interconnectors, adapters, wired/wireless network cards, or any other means of enabling data communication between the MADCAD 100 and another device. For example, the I/O interface 118 may comprise a number of USB ports that may be used to extract data from the memory 104 (e.g. to create a backup), access any of the modules for updating or debugging, test/calibrate the load cell 108 or the camera array 110 or the LED array 114, or test/troubleshoot/debug any other sensor, module or function of the MADCAD 100.

The MADCAD 100 may additionally comprise a global positioning system (GPS) that may enable logging of geospatial coordinates. Additionally, the MADCAD 100 may incorporate a real-time clock (RTC) used to append any data with a timestamp.

The components of the MADCAD 100 may be powered by an AC or DC power source 126, such as a solar panel, a battery, a fuel cell, a tidal stream generator, etc. Any power source may be used and is within the scope of the exemplary embodiments described herein. Alternately, the components of the MADCAD 100 may be powered by a separate, external power source. Alternately, any individual component of the MADCAD 100 may receive power from an intrinsic power source (such as a button-cell battery or a 9-volt battery, a solar panel, a fuel cell, etc.).

Any of the above power sources may be rechargeable through a charging unit of the MADCAD 100. Potential charging sources may derive power as solar power through a solar panel of the MADCAD 100, or through a tidal stream generator of the MADCAD 100. Other charging means may be used to recharge the power source 126 or any other power source of the MADCAD 100. The MADCAD 100 may also comprise a cooling fan and vents to aid in temperature regulation of the various sensors and modules of the MADCAD 100, including the power source 126. The cooling fan and vents do not compromise NEMA standard compliance. The power source 126 may be coupled to a power button allowing a user to power on/off the MADCAD 100.

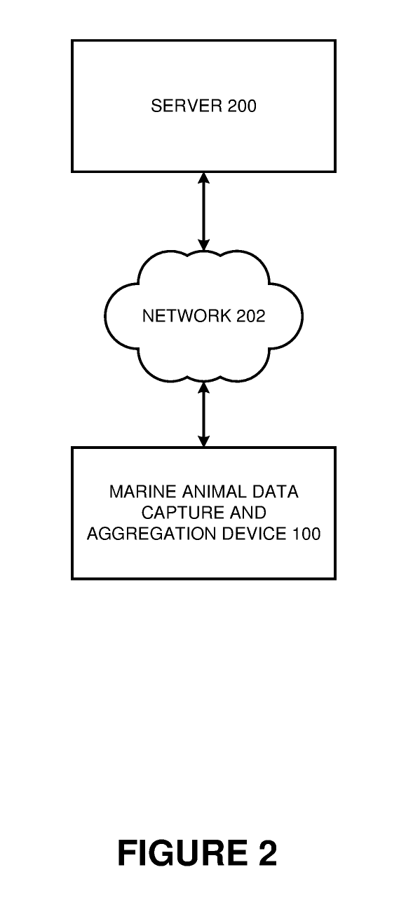

Reference is now made to FIG. 2, which is a block diagram illustrating the MADCAD 100 of FIG. 1 as a client communicating with a server 200 through a network 202, according to one or more embodiments. In embodiment, the I/O interface 118 may comprise a network interface that may enable communications over the network 202. The network 202 may be any personal area network (PAN), wide-area network (WAN), local area network (LAN), or edge network. Examples of WANs that constitute one or more of the preferred embodiments of the MADCAD 100 include but are not limited to cellular networks and the Internet. In the case of a cellular network, the MADCAD 100 may incorporate a GSM or CDMA-enabled mobile device (such as a mobile phone or tablet) or on-board chip. In the case of a cellular network, the MADCAD 100 may be communicatively coupled to an edge network, which may be easily accessed in lieu of more robust network connections on the open seas or at harbor. An edge network may comprise of one or more GSM cells that may enable cellular devices to access a cellular network through cellular towers of another cellular network.

In one embodiment, multiple MADCADs may constitute a group of MADCADs communicatively coupled in an intranet. Within the intranet, data may be synchronized between the MADCADs to improve data integrity and relay vital sea information between boats on the same or different harvesting operations. Any data may be communicated between MADCADs or other devices in an intranet as needed to fully perform any function described herein.

The server 200 may comprise one or more databases for storing data generated by the MADCAD 100. While a platform for remote sensing in fishing environments has been disclosed in Pub. No. 2015/0156998, the MADCAD 100 may be a data collection endpoint that may enable a microtransactions-based incentive system for users of the MADCAD 100 that can offset the initial cost of the MADCAD 100 and help fishing businesses stay profitable.

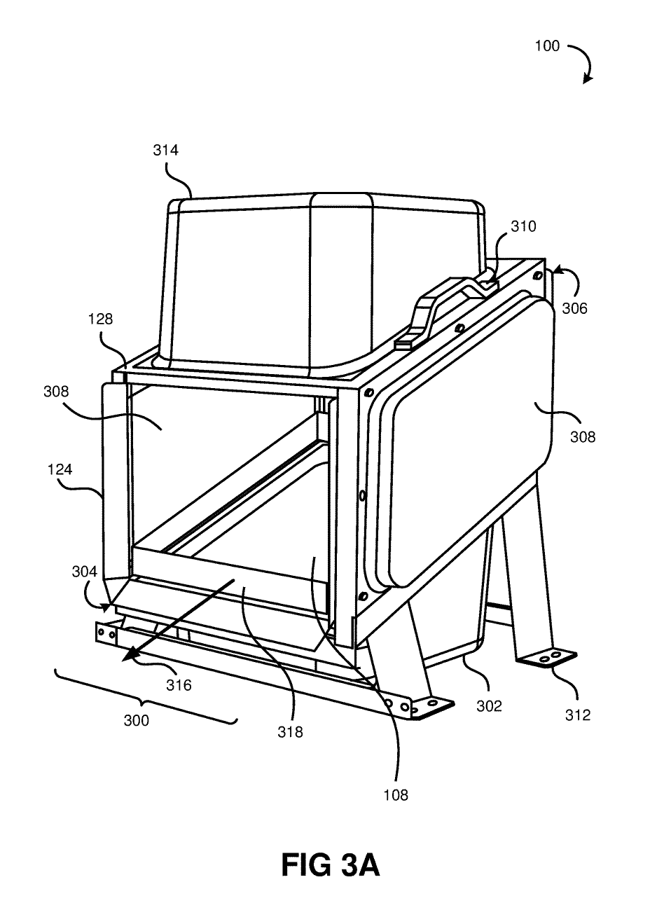

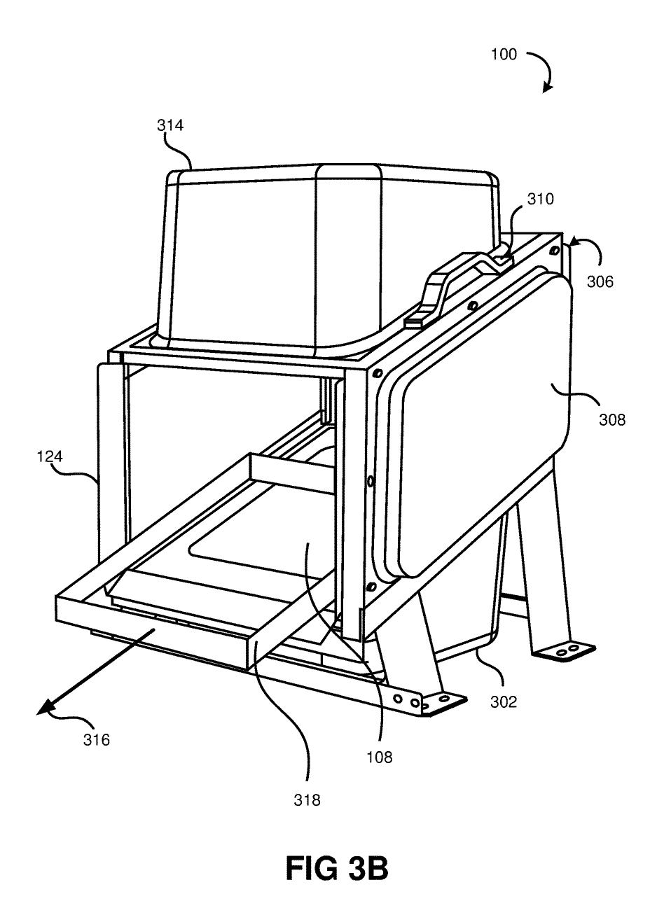

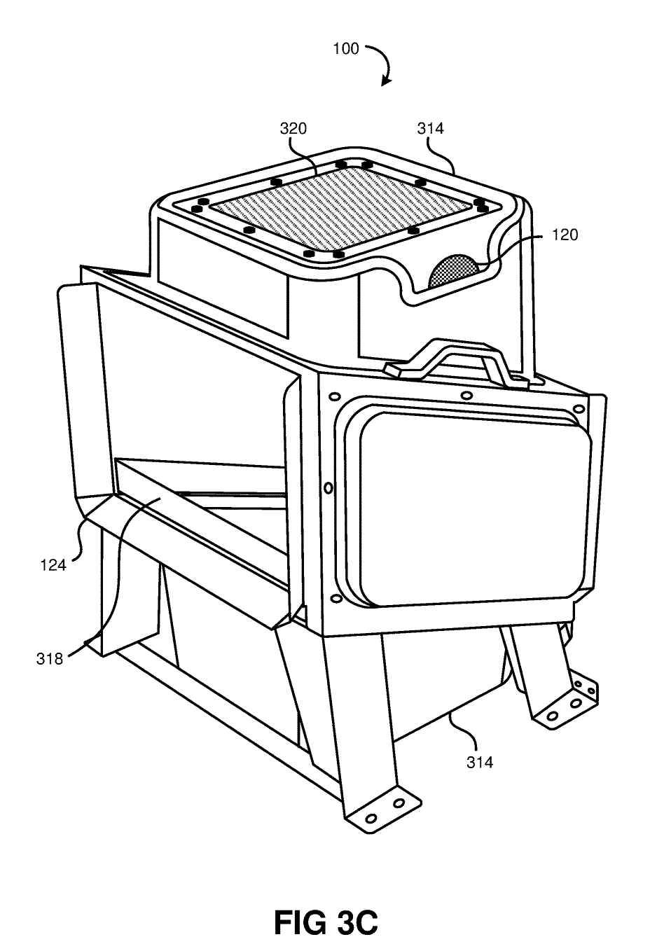

Reference is now made to FIG. 3A, which is a front perspective view of the MADCAD 100 of FIG. 1, according to one or more embodiments. In one embodiment, the structure of the MADCAD 100 comprises a manifold 128 having a slide 300 under which may be a waterproof container 302 within which one or more of the sensors and/or modules may reside. The waterproof container 302 may be lockable. Since the slide 300 may comprise a transparent surface (made of glass, distortion-free acrylic, or other suitable material) through which the sensors and/or modules, such as the camera array 110 and the LED array 114 may operate. The slide 300 may slope downwards to a first opening 304 and may slope upwards to a second opening 306. The MADCAD 100 may comprise further openings, but in the embodiment illustrated in FIG. 3A-C, only two are shown (in the front and in the back). On either side of the slide 300 may be flotation chambers 308 designed to keep the MADCAD 100 afloat should the MADCAD 100 happen to go overboard. Handles 310 coupled to the MADCAD 100 may facilitate handling of the MADCAD 100 or for the MADCAD 100 to be securely fastened with rope. The legs 312 of the MADCAD 100 housing may comprise further attachment points such that the MADCAD 100 can be securely coupled to the deck of a vessel. Alternately, the legs 312 of the MADCAD 100 may be coupled to wheels that may facilitate dockside or processing plant mobility.

Waterproofing the entire MADCAD 100 may facilitate its reliable use in marine environment conditions (i.e. high humidity, oxidation, barnacles, etc.) in the long term. As such, the MADCAD 100 may be hosed down regularly to prevent the buildup of particles that may prevent reliable data capture through the various components of the MADCAD 100.

An additional waterproof container 314 may be positioned above the slide 300, thus limiting the number of openings to two (i.e. for ingress and egress). The waterproof container 314 may also be lockable. In an alternate embodiment, the waterproof container 314 may be removed to provide an upper opening that may facilitate the operation of one or more other embodiments of the MADCAD 100 described in FIG. 9. In any case, the MADCAD 100 illustrated in FIG. 3A directs a deposited marine animal downward along the direction of arrow 316.

Operation of the MADCAD 100 may typically involve first receiving a marine animal into the second (e.g. back) opening 306 of the MADCAD 100 such that the marine animal slides down the slide 300 but is kept stationary for a requisite period of time in order to enable capture of relevant data from the marine animal. As such, between the first opening 304 and the second opening 306, a bottomless drawer 318 may be slidably disposed above the surface of the slide 300 and mechanically coupled to the sides of the MADCAD 100 such that the bottomless drawer 318 prevents the downward movement of the marine animal. The marine animal may need to be stationary for a requisite period of time during which data pertaining to the marine animal may be captured (e.g. images, weight, presence of eggs, etc.). During operation of the MADCAD 100, the bottomless drawer 318 may slide downward along the slide 300 to allow the marine animal to be ejected from the MADCAD 100.

Reference is now made to FIG. 3B, which is a perspective view showing operation of the bottomless drawer 318 of the MADCAD 100, according to one or more embodiments. The bottomless drawer 318 may slide downward along arrow 316 to an extent necessary to allow the deposited marine animal to continue sliding down the slide 300 and exit the MADCAD 100 through the open floor of the bottomless drawer 318.

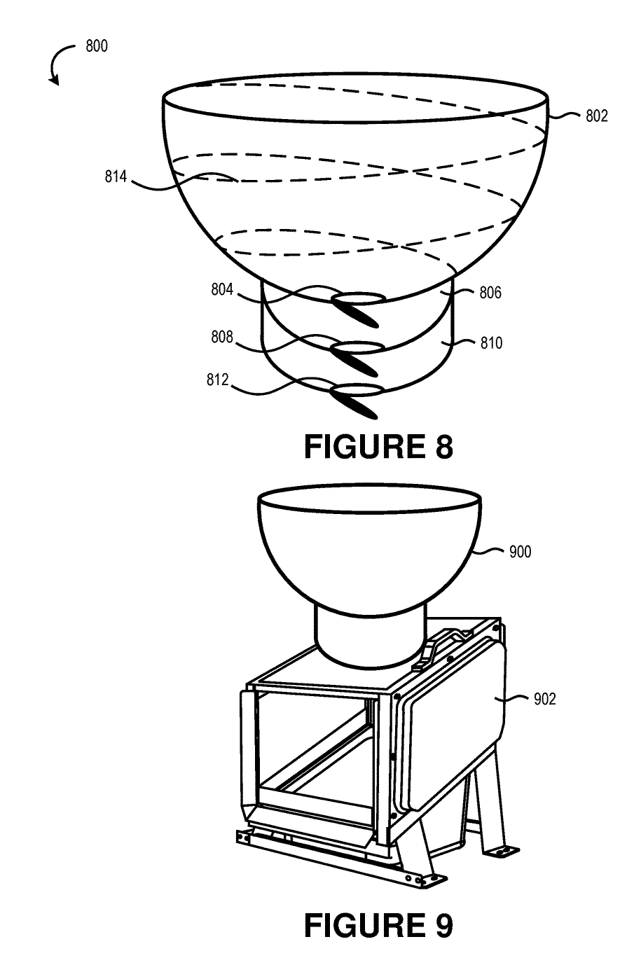

Other methods for keeping the marine animal stationary during data capture may be used and are within the scope of the exemplary embodiments described herein. For example, the slide 300 may comprise an electromechanical means for effecting the slope of the slide 300. As such, the slide 300 may be made flat or sloping at any angle. The electromechanical means may comprise a gear and motor system disposed within the housing of the MADCAD 100 so as to enable the slope of the slide 300 to be adjusted. Other structural configurations of the MADCAD 100 may be used based on the difficulty of capturing data from specific species of animal. For example, a crab may be caught on the bottomless drawer 318, so a more economical means of ejecting the crab may be shown in FIGS. 8-9, which illustrate a tank embodiment of the MADCAD 100.

Reference is now made to FIG. 3C, which is a rear perspective view of the MADCAD 100 of FIG. 1, according to one or more embodiments. In one embodiment, the waterproof container 314 may comprise a solar panel 320 that may provide power to the various components of the MADCAD 100 or may facilitate charging of a battery power supply housed within the waterproof container 302 or the waterproof container 314. In an embodiment in which the MADCAD 100 does not comprise a waterproof container 314, the MADCAD 100 may simply comprise a surface that is mirrored internally (in order to facilitate image capturing within the MADCAD 100) and may comprise a solar panel 320 externally (i.e. on the outer portion of the surface).

In the waterproof container 314 embodiment, the waterproof container 314 may comprise a speaker 120. Alternately, the waterproof container 302 may comprise the speaker 120. The speaker 120 may be used to emit a noise to call the attention of a user of the MADCAD 100 to a recently slid marine animal.

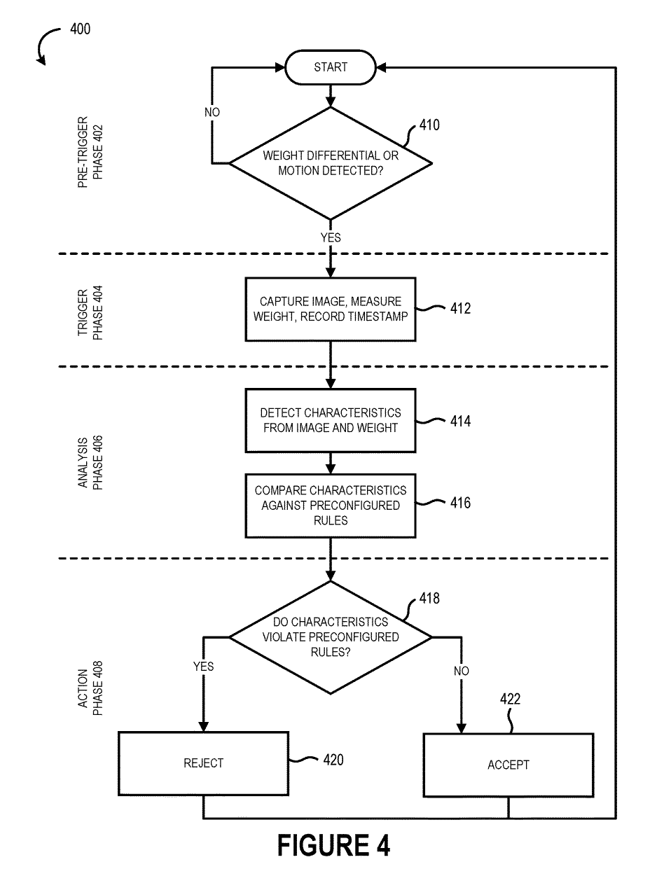

Reference is now made to FIG. 4, which is a decision flow chart illustrating a data capture method 400 (or data capture session 400) of the MADCAD 100 of FIG. 1, according to one or embodiments. The data capture method 400 may comprise a pre-trigger phase 402, a trigger phase 404, an analysis phase 406, and an action phase 408. The data capture method 400 may necessarily involve one or more modules of the MADCAD 100, including but not limited to the load cell 108, the motion detection module 116, the camera array 110, and the analysis module 112. Fewer or additional modules may be involved and are within the scope of the exemplary data capture method 400 described herein. As such, the data capture method 400 as described may represent one of many possible data capture methods—different modules may be used or different parameters may be measured/assessed, thus allowing the data capture method 400 to be configured according to the data capture needs of the operation for which it is purposed.

During the pre-trigger phase 402 as shown in FIG. 4, the MADCAD 100 may start in a standby mode 410, during which the processor 102 may be configured to detect a weight differential through the load cell 108, and/or the processor 102 may be configured to detect motion within the MADCAD 100 through the motion detection module 116. As such, there may be one or more than one trigger that may be accepted during the pre-trigger phase 402. For example, a deposit of a crab into the MADCAD 100 may be detected by the motion detection module 116, or the weight of the deposited crab may cause a weight differential detectable through the load cell 108. In any case, once triggered, the MADCAD 100 may proceed to process 412.

During the trigger phase 404 and in particular, process 412, the processor 102 may activate the camera array 110 and optionally LED array 114 to capture an image. Alternately, or in addition, in process 412, a weight may be measured through the load cell 108. In any case, a timestamp and geospatial coordinates are also recorded and stored along with the image and/or the weight measurement in the memory 104. In the example described above, the camera array 110 may capture one or more images of the deposited crab. In addition or in the alternate, the weight of the crab may be measured through the load cell 108. Since movement of the crab may affect the weight measurement, multiple measurements may be taken and an average thereof calculated to improve measurement consistency. Furthermore, an animal identifier may be generated for the specific animal. The captured image(s) and weight measurement(s) may be used as inputs during the analysis phase 406.

During the analysis phase 406, one or more characteristics of the animal deposited in the MADCAD 100 may be detected, in process 414, based on the image captured and/or the weight measured during process 412 of the trigger phase 404. In addition, in process 416, the characteristics may be compared against one or more rules preconfigured for the particular data capture session. For example, a deposited crab's image may be analyzed to determine the crab's size and gender, or any other characteristic that the MADCAD 100 is configured to determine. Size, gender, species, and/or presence of eggs may be compared against a threshold preprogrammed into the MADCAD 100. The threshold may be based on the need for regulatory compliance—such as a need to prevent harvesting of breeding crab so as to facilitate sustainable crab fishing. In another example, a specific type of species of seafood may be associated with a greater market demand than other species of seafood that may also be caught during the same data capture session. As such, the MADCAD 100 may be preconfigured to detect the particular species. In any case, the results of the analysis phase 406 are used as inputs in the action phase 408, the outputs of which are integral to the workflow of fishermen.

In the action phase 408, an evaluation 418 may evaluate the results of the process 416 of the analysis phase 406. Based on the evaluation 418, the deposited animal may be rejected in process 420 or accepted in process 422. If the one or more characteristics violate the one or more preconfigured rules, the evaluation 418 may yield to process 420. For example in process 420, an alarm may be triggered and sounded through the speaker 120 or displayed through the display screen 122. For example, if a deposited crab is deemed to be carrying eggs, the alarm may be triggered and an operator may respond to the alarm by removing the deposited crab from the MADCAD 100 and returning it to the sea. If the preconfigured rule(s) is/are not violated, then the evaluation 418 may proceed to process 422. In any case, the bottomless drawer 318 may be activated and the contents of the MADCAD 100 may be ejected. Other appropriate means of controlling the egress, ingress, and internal positioning of the deposited animal may be used. Once the contents are ejected, the MADCAD 100 may reset and return to the standby mode 418 to repeat the data capture method 400 for another deposited marine animal.

The standby mode 418 of the data capture method 400 may be active upon powering the MADCAD 100. However, the data capture method 400 may not proceed past the standby mode 410 without first gaining authorization. As such, each data capture session may be initiated through a session initiation stage that involves 1) intake of credentials to authorize the data capture session and facilitate aggregation and auditing of the captured data and 2) calibration of the load cell 108 and/or other modules to ensure consistency during the data capture. To facilitate session initiation and calibration of the MADCAD 100 components, a customized card (“custom card”) may be deposited within the MADCAD 100 to facilitate 1 and 2 above.

Reference is now made to FIG. 5, which is a schematic diagram of a custom card 500 used for session initiation and calibration by the MADCAD 100 of FIG. 1, according to one or more embodiments. The custom card 500 may follow a particular convention and may comprise at least one or more elements readable by the MADCAD 100. In one embodiment, the custom card 500 may comprise a user identifier 502 scannable by the camera array 110 and one or more weights 504 for calibrating the load cell 108.

The user identifier 502 may be conveyed through any visual or non-visual method. In one embodiment, the user identifier 502 may be a barcode. In another embodiment, the user identifier 502 may be printed on the custom card 500. If printed on the custom card 500 as text, the user identifier 502 may be recognized through optical character recognition (OCR). The user identifier 502 may alternately be encoded into an RFID chip or an NFC tag, provided that the MADCAD 100 incorporates a corresponding reader. Other methods of applying the user identifier 502 to the custom card 500 may be used and are within the scope of the exemplary embodiments described herein.

The user identifier 502 may be associated with a user of the MADCAD 100, a fishing vessel, a fishery, a lessee of the MADCAD 100, or any other entity. In one embodiment, when the custom card 500 is placed atop the load cell 108 of the MADCAD 100, the MADCAD 100 may detect a weight differential or detect motion (due to the MADCAD 100 being in standby mode 410 once powered on) and subsequently capture and scan the custom card 500. Since the custom card 500 follows a standard convention, (one possible embodiment of which is shown in FIG. 5), the MADCAD 100 may detect that the custom card 500 has been placed atop the load cell 108 by recognizing one or more of the various recognizable elements of the custom card 500. Upon detecting placement of the custom card 500, the MADCAD 100 may retrieve the user identifier 502, in this case by scanning the user identifier 502, which is a barcode. Alternately, the MADCAD 100 may not enter the standby mode 410 until the custom card 500 is scanned, the user identifier 502 is authorized, the load cell 108 is calibrated, and the data capture session is initiated.

The one or more weights 504 may comprise one or more weights of predetermined masses. The one or more weights 504 may be removable from the custom card 500 in order to set the custom card 500 to an appropriate weight during a calibration of the load cell 108. In a plurality of weights embodiment as shown in FIG. 5, the one or more weights 504 may be appropriately distributed throughout the custom card so as to balance the weight across the custom card 500. For example, a calibration process may involve removing all of the one or more weights from the custom card 500 to set a minimum and may subsequently involve replacing the one or more weights 504, the MADCAD 100 issuing a sound through the speaker 120 after each replacement. Any calibration process may be used to calibrate the load cell 108 or aid the calibration process and is within the scope of the exemplary embodiments described herein. For example, the MADCAD 100 may additionally comprise an accelerometer that may account for the rocking of a fishing vessel during data capture. The distribution of the one or more weights 504 may aid in the determination of the orientation of the MADCAD 100 and subsequent modification of the weight measurement through the load cell 108.

In one embodiment, the MADCAD 100 may also comprise a water level detection sensor. In one embodiment, if the MADCAD 100 is used to enumerate fish, a water stream may the principal means of controlling ingress, egress, and internal positioning of the fish within the MADCAD 100. For example, a stream of water having one or more fish may be routed through the MADCAD 100, which may comprise blast doors that may be lowered or raised to halt the stream. The water level detection sensor may be used to determine the level of water.

Reference is now made to FIG. 6, which is a data hierarchy 600 showing relationships between one or more identifiers that may be utilized during aggregation of data captured through the MADCAD 100 of FIG. 1, according to one or more embodiments. At the top of the data hierarchy 600 may be a load identifier 602 associated with a load 604. As such, the load identifier 602 may be analogous to the session ID of appl. Ser. No. 14/735,799. Each load 604 may be shipped separately and may be associated with a load identifier 602. Each load 604 may comprise a particular biomass, the related details of which may be fed through the MADCAD 100 to collect relevant data through one or more data capture sessions 608. Each such data capture session 608 performed by the MADCAD 100 may be associated with a session identifier 606. Each data capture session 608 may be initiated separately using the custom card 500 and as such, a user identifier 610 of a user 612 may be associated with the session identifier 606. The user identifier 610 may also be associated with an owner identifier 614, which may be associated with an owner of the MADCAD 100. At the bottom of the data hierarchy 600 is an animal identifier 616, which may be issued to a biomass unit 618 of the load 604.

The data hierarchy 600 provides for robust tracking of an harvesting operation from the highest level—the shipment of goods (i.e. the load 604)—to the lowest level—each individual unit being shipped (i.e. biomass unit 618). This high resolution identification system allows for precise tracking of every aspect of a harvest while fishermen perform their duties. Although the various identifiers may be originated at different stages of the harvesting operation, the session identifier 606 may be generated through a session initiation process that involves the custom card 500.

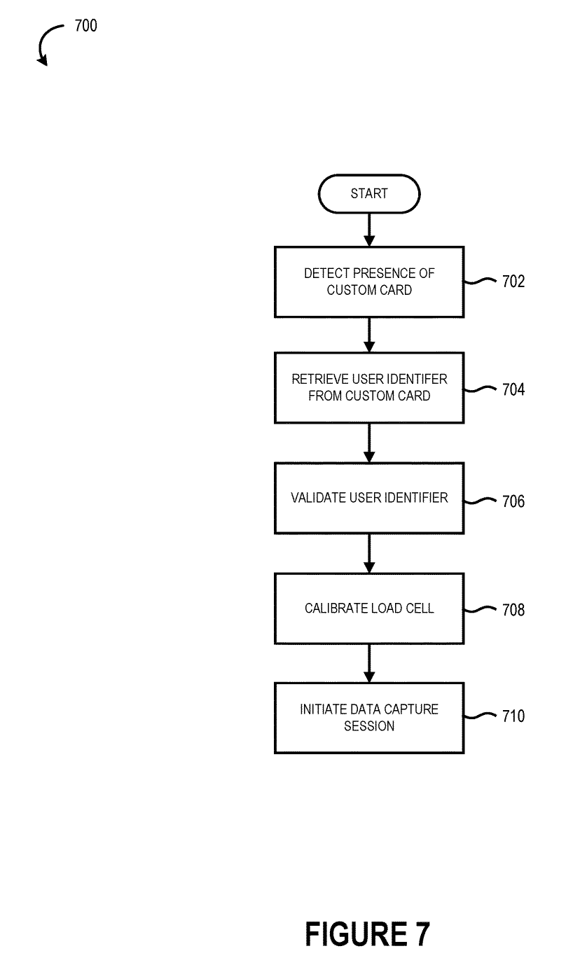

Reference is now made to FIG. 7, which is a decision flow chart illustrating a session initiation process 700 using the custom card 500 of FIG. 5, according to one or more embodiments. In one example, a user of the MADCAD 100 (e.g. a fishing vessel worker) may be provided a custom card 500. The user may power on the MADCAD 100 on and place the custom card 500 on the load cell 108. In process 702, the MADCAD 100 may detect the presence of the custom card 500. In process 704, the MADCAD 100 may retrieve a user identifier 610 from the custom card 500 by capturing an image of the custom card 500 through the camera array 110. In process 706, the MADCAD 100 may validate the user identifier 610 by comparing the user identifier 610 against a whitelist of user identifiers that are authorized to use the MADCAD 100. Alternately, the custom card 500 may comprise an owner identifier 614 in addition to or in place of the user identifier 610 and process 704 may involve retrieval and validation of the owner identifier 614. In one embodiment, the custom card 500 may comprise a private key or a hashed key that may be utilized in an authentication process. If process 706 fails, the MADCAD 100 may halt the session initiation process 700. In process 708, the MADCAD 100 may calibrate the load cell 108 using the one or more weights 504 of the custom card 500. Once the load cell 108 is calibrated, the data capture session 700 may be initiated, in which case the MADCAD 100 will enter the standby mode 410 of the data capture session 400. The session initiation process 700 may also comprise a process for determining a system health status by checking each component of the MADCAD 100 for proper operation.

Retrieval of the user identifier 610 may be integral to the session initiation process 700—recordation of users involved in each data capture session is vital to the auditing process and is provides valuable information for fishing operation managers, regulation authorities, or any other stakeholder.

In another embodiment, the custom card 500 may be a subscriber identification module (SIM) card. The SIM card may be communicatively coupled to the processor 102 (especially in the case that the processor 102 and memory 104 are embodied in a smartphone). User registration may occur automatically upon insertion of the SIM card. Facilitated through GSM networks, the user registration process may allow the MADCAD 100 to seamlessly integrate into modern harvesting workflow. Furthermore, utilization of a SIM card may also enable issuance of one or more microtransactions in exchange for data generated and communicated to the server 200 through cellular, data, or edge networks. In another embodiment, the MADCAD 100 may come pre-packaged with a SIM card that may be sealed (and thus unremovable) or replaceable.

In one example, an operator of the MADCAD 100 may place the custom card 500 atop the load cell 108 once a particular biomass is harvested and brought on deck for data capture through the MADCAD 100. The MADCAD 100 may recognize and validate the user identifier 610 (or the owner identifier 614) of the user's custom card 500, commence a data capture session 608 and associate all captured data with the user 612. In another example, the user 612 may insert a SIM card unique to the user 612 into the MADCAD 100 to initiate a data capture session. The SIM card may be recognized as being associated with the user 612 and all data captured through the MADCAD 100 may be associated with the user 612. Alternately, the SIM card may be associated with an owner of the MADCAD 100. Alternately, the MADCAD 100 may initiate the data capture session 608 by inserting an authorization dongle (e.g. a flash drive with a private key) into the I/O interface 118. All captured data and associated user information may be communicated to the server 200 to facilitate data protection, validity, and auditing to ensure data integrity. The data may be compressed and encrypted before communication.

The user registration performed through the session initiation process 700 may facilitate a nodelocking licensing method by which a user (company, individual, etc.) may be licensed to use a number of MADCADs (nodes) in a network of MADCADs (node network). The MADCADs may be owned by or leased to the user. Nodelocking may further aid in determining the location and thus the source of data captured through an MADCAD as well as associated user data. For example, an MADCAD may be licensed to a user undergoing a blue swimmer crab harvesting operation. The MADCAD may aid the user in sorting the blue swimmer crab—e.g. alerting the user to presence of female crabs with eggs (to be returned to the sea to reduce negative environmental impact), alerting the user to presence of bycatch, communicating commands to downstream processors (e.g. coupled MADCADs, distribution/processing plants, etc.). A nodelocked MADCAD may allow seamless initiation of data capture sessions and may not require a lengthy authentication process when initiating a data capture session or communicating captured data to the server 200. Nodelocking may also enable a business model by which micropayments are offered in exchange for data captured through a nodelocked MADCAD.

In another embodiment, the MADCAD 100 may be utilized in a microtransaction incentive system. Simply put, a user may receive micropayments in exchange for data captured through the MADCAD 100. The number and magnitude of micropayments may be proportional to the amount of data provided (e.g. number and/or length of sessions).

In a fishing operation with one or more fishing vessels, each fishing vessel may utilize one or more MADCADs to capture data from their harvests. After completing a harvest, a fishing vessel may communicate the data captured through the MADCAD to a server through a network. The data communication may be during or after a data capture session or may be scheduled periodically. One example protocol that may be used is SMS messaging, which may be supported by a cellular network (or an edge network), especially because cellular networks provide more coverage than data networks and are suitable for the task of communicating relatively simple data structures, especially on the open seas. On the open seas, a fisher may be able to use a cellular-enabled smartphone, but not a desktop, so SMS is a preferred embodiment as a means for communicating data in exchange for micropayments directed to the account holder of the SIM card inserted into the smartphone or to the user associated with a user identifier of a particular session. Though any other communication protocol using any other device communicating through any network may be used to facilitate this data-for-cash business model, SMS may be preferred for wild catch or aquaculture harvesting environments.

The data captured and communicated through the MADCAD 100 may also be any data related to the biomass from which the data is captured and may comprise, but not be limited to, one or more of the following: total weight of harvest; species of marine animals caught; number of males; number of females; total number of marine animals caught; weight of specific animals caught (with weight measurements associated with particular animal identifiers); geospatial coordinates of harvest and data capture stages (pre-trigger phase 402, trigger phase 404, analysis phase 406, action phase 408); timestamps of session initiation, user registration and/or calibration; presence of egg-laying animals; names of personnel involved in harvest; user identifiers associated with any user that initiated a data capture session; load identifier associated with any shipment/load; session identifier during which data was captured; animal identifier for specific animals captured; data associated with specific animal identifiers; results from other post-processing modules, etc.

The above data and more may be encoded into a machine-readable medium that may provide for optimal, compressed, cost-effect communication. Especially in the SMS microtransaction embodiment described above, the data (or any subset of data) may be encoded into a format and size that may easily be communicated to a central server via SMS. For example, especially for small amounts of data, the data may be stored in one or more 8 or 16-bit words. Any of the words may be variable or fixed in length and may be decoded by the processor 102 of the server 200 and the data stored in a memory of the server 200. Aggregated and saved in a secured cloud database, the data may be viewable by stakeholders of the harvest through a browser having access to the secured cloud database. Read-only data access may be provided to certification entities to facilitate receipt of sustainability certification data.

A maintenance mode of the MADCAD 100 may be initialized in order to facilitate maintenance/replacement of any constituent elements of the MADCAD 100. Any software or firmware of the MADCAD 100 may be needed to updated or a particular hardware module may require replacement or troubleshooting. For example, any of the cameras or mirrors of the camera array 110 may require repositioning, refocusing, or replacing. The LED array 114 may require LEDs to be replaced.

The MADCAD 100 of FIG. 1 may play a vital role in the integration of big data generators in the fishing industry that facilitate complete traceability of data to the point of harvest. During and/or after harvesting, data collection/aggregation is a low priority when profitability depends on minimizing time-intensive ancillary tasks (furthering compliance, removing bycatch, detecting presence of egg-bearing females) and maximizing marketable yield.

In maximizing their yield however, fishermen may take certain risks, such as spending less quality time ensuring compliance with bycatch quota regulation, or mistakenly sorting a crab into the wrong shipment. Additionally, fishermen must balance their time between taking steps to improve their marketable catch in the short term vs. logging harvest data to improve consistency and profitability in the long-term. Due to the pressure of regulations and market demands, fishermen may fail to achieve a sustainable fishing practice and may contribute to overfishing and the wholesale elimination of marine ecosystems. Furthermore, fishermen that are forced to ignore certain sustainable practices may be unable to maintain profitable catches when faced with heavy fines or season closures due to unchecked levels of easily preventable bycatch. Overall, the current state of the fishing industry leaves much to be desired by way of data collection, which can seamlessly improve efficiency and profitability simply by integrating into current workflow, but also provide an alternate stream of revenue since data is now viewed as a valuable commodity to a vast number of stakeholders.

The MADCAD 100 may play a valuable role in improving fishermen workflow efficiency by taking over the time-intensive inspection and sorting tasks that fishermen must do to comply with federal or state regulation(s). With less time spent on tasks that do not contribute to profitability (e.g. sorting crab, checking for eggs, logging data, enumerating bycatch, authenticating catch-related data, enabling verification for traceability, etc.), overhead can be minimized (less fuel spent, fewer man hours needed, fewer laborers needed, etc.).

The MADCAD 100 provides a fishermen with a valuable logging and tracking solution that facilitates planning of future harvests, negotiation with shippers and processors, and other business-related interests that may be informed by an intimate knowledge of the macro and micro details of each harvest. Armed with a bank of data generated over several harvests, fishermen may be able to predict when and where breeding grounds may be and thus may be able to steer away from such sites and reduce liabilities due to fines. Communication of this and related information to other fishers may prevent early season closure and enhance economies in certain fishing communities. Thus, an extensive log of harvesting activities provides fishermen with a reference that can be used by the fishermen, sold to other stakeholders, or used as proof of sustainable practices.

The MADCAD 100 may provide key accountability and sustainability measures that may satisfy various stakeholders of a fishing operation. Processing plants may be able to publicize data associated with processed seafood to meet high consumer demand for sustainable fishing practices. Without a high-resolution data capture solution, processing plants and other wholesale distributors, shippers, or merchants of seafood may convey incorrect, incomplete, imprecise, or inadequate information about the seafood they offer. For example, shippers may benefit by quickly integrating load identifiers into their load tracking logistics. Fishery owners may be able to track employee work hours and activities by viewing user identifier-related information. The MADCAD 100 may also enable more comprehensive certification and compliance adherence. Buyers may be able to verify that the seafood they purchase was legally harvested and the labor was not provided by slaves. Restaurants may be able to provide a patron with the specific data related to the crab that they are served (place caught, fishing vessel that caught the crab, environmental conditions at the time of catch, weight/gender/species of crab, and any other information that a consumer may want to know or that a restaurant may wish to provide). Session identifiers may be used to award fishermen for the data captured for each data capture session.

Furthermore, the data generated through the MADCAD 100 may be reported to oversight agencies to facilitate compliance with government regulations, reduce the chance of incurring fines, prevent early season closure, and eliminate the need for costly inspection. Government oversight organizations (such as the National oceanic and Atmospheric Administration (NOAA) and similar or affiliated fish and wildlife organizations) may require regular use of the MADCAD 100 by fishermen and may require regular reporting of data generated through the MADCAD 100. As such, a government oversight agency may wish to implement an incentive-based system that reduced overall fines based on reported use of the MADCAD 100.

Data captured and communicated by the MADCAD 100 may be viewed as a valuable commodity to be monetized and utilized by numerous stakeholders. The big data industry thrives on the sale and use of massive amounts of information—such uses include statistical analysis, business/financial planning and predictions, advertising, consumer reporting, etc. The various stakeholders of a particular harvest may all benefit from a reliable source of precise, comprehensive data associated with the entire route of a particular harvest, from origination to consumption. As such, the data generated by the MADCAD 100 may be commoditized and used as a revenue stream by owners and/or lessees of the MADCAD 100.

The MADCAD 100 may be applied to the tracking and load propagation system described in appl. Ser. No. 14/735,799. The MADCAD 100 may be integrated into the tracking and load propagation system described in appl. Ser. No. 14/735,799 to provide a catch-to-plate tracking solution for a seafood supply chain through the creation of unique session identifiers (analogous to load identifier 602 of FIG. 6). The load identifier 602 (i.e. a particular load of marine animals to be shipped) may be associated with more than one session identifier 606, and may comprise animals each of which be associated with an animal identifier 616. Each identifier may be used as primary keys in a corresponding database storing relations between each identifier and any relevant data relevant to the identifier. For example, a harvest of crabs during a fishing voyage may be split into two shipments A and B. A corresponding load identifier A and load identifier B, respectively, may generated through the MADCAD 100. Specific data capture sessions may generate session identifiers that may be associated with either load identifier A or load identifier B. The generation may be automatic or manual (e.g. through fisher input).

In one embodiment, the MADCAD 100 may recognize multiple marketable species of fish captured in one voyage through one or more data capture sessions performed during the voyage. During or after the one or more data capture sessions, the MADCAD 100 may compare a species data against a set of target species. The set of target species may be based on the interest(s) of one or more distributors, processors, or other stakeholders. In one example, a distributor may request a shipment of blue swimmer crab—thus causing generation of a load identifier for the shipment. All animal identifiers of any blue swimmer crab caught through any of the data capture sessions may be associated with the load identifier, as are the session identifiers and corresponding user identifiers. Any of the relevant data associated with the load identifier may be provided to the distributor, thus providing direct access to data generated at the time of processing the catch right after harvest.

Reference is now made to FIG. 8, which is a schematic of a tank 800 having one or more chambers, according to one or more embodiments. The tank 800 may comprise a holding chamber 802, a first drain 804 leading to a staging area 806, a second drain 808 leading to an identification (ID) chamber 810 which comprises a third drain 812. The purpose of the tank 800 is to aid in automation of the enumeration of marine animals. Marine animals may be deposited into the holding chamber 802 (with or without water, though preferably and typically with water). The holding chamber 802 may be a shaped as a tapering funnel and may comprise a internal spiral ramp 814. Alternately, the holding chamber 802 may be spun to generate centrifugal force that may push the deposited marine animals to the sides of the smooth internal surface of the holding chamber 802. Especially when crabs are considered, marine animals may pile on top of each other or get caught and may usually require manual input to free the marine animal(s) of entangelements. The holding chamber 802 may also comprise a set of slowly sweeping long-bristle brushes on the top of the holding chamber 802 that may rotate and encourage movement of marine animals along the spiral ramp 814. This movement along the spiral ramp 814 may aid in disentangling crabs from each other or parts of the tank 800 and promoting movement in a single file.

Movement of marine animals from the holding chamber 802 to the staging area 806 and the ID chamber 810 may be controlled by the opening/closing of the first drain 804 and the second drain 808. Evacuation of the contents of the tank 800 may be controlled by opening/closing of the third drain 812. The first drain 804 may be opened to evacuate the contents of the holding chamber 802 into the staging area 806. When a marine animal is evacuated through a drain, the drain may close automatically due to the change in water pressure (as long as water is also being evacuated). Thus, the drains may be engaged to advance the marine animal from chamber to chamber. The ID chamber 810 may be used to capture data from the marine animal in a similar method to the data capture session 400 described above. As such, the tank 800 may be a stand-alone device that works similarly to the MADCAD 100 but may provide considerable utility to large-scale wild catch fisheries (especially for harvesting crab).

Reference is now made to FIG. 9, which shows a tank 900 coupled to a modified MADCAD 902 with the waterproof container 314 removed, according to one or more embodiments. The tank 900 may be coupled to the MADCAD 902 such that the MADCAD 902 performs substantially the same functions as the ID chamber 810 of the tank 800. The tank 900 may evacuate its contents through the top of the MADCAD 902 and directly onto the load cell 108. As such, the tank 900 may allow fishermen to load an entire harvest (or a subset of the harvest) into the tank 900 and the tank 900 may automatically evacuate the contents of the holding chamber 802 into the staging area 806 and subsequently into the MADCAD 902 where the contents are sorted and analyzed. The tank 900 may optionally comprise the ID chamber 810 and thus may aid or replace the data capturing facilities of the MADCAD 902.

The tank 900 may be coupled to the MADCAD 902 through a mating flange and thus may be able to engage in bi-directional communication with the processor 102 and thus, the sensors and/or modules of the MADCAD 902.

The tank 800/900 allows for integration of a sloping sorting table coupled to the top of the tank 800 and comprising a hole positioned over the tank 800 through which crabs or fish may fall through to the tank 800. The sloping sorting table may slope downwards and gradually diminish in width until the width of the sloping sorting table is equal to the width of the hole (or the rim of the holding chamber 802). Fishermen may typically utilize the sloping sorting table by dumping a harvest (or part of a harvest) of crabs (or fish or any other marine animal) onto the sloping sorting table and preliminarily remove any garbage or obvious bycatch from the table before they enter the tank. The slope of the sloping sorting table may be adjusted as necessary to change the speed of progression of the fish. Seawater may stream down the sloping sorting table and enter the tank 800. Alternately, the sloping sorting table may be used directly with the MADCAD 902 (i.e. without the tank 800).

Although the present embodiments have been described with reference to specific example embodiments described herein and illustrated through the figures, it will be evident that various modifications and changes may be made to these embodiments without departing from the broader spirit and scope of the various embodiments. It is to be understood that the specific order or hierarchy of steps in the methods or processes disclosed is an illustration of exemplary processes. Based upon design preferences, it is understood that the specific order or hierarchy of steps in the methods or processes may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

What is claimed is:

1. An apparatus, comprising:
a processor;
a memory;
one or more sensors;
wherein the processor is configured to execute a set of instructions stored in the memory, the set of instructions causing the apparatus to perform a data capture session in which the apparatus:
detects a weight differential through the one or more sensors;
upon detecting the weight differential, measures a weight and captures an image through the one or more sensors; and
based on the captured image, compares one or more characteristics derived from the image or the weight to one or more preconfigured rules of the processor.

2. The apparatus of claim 1, wherein the data capture session further comprises detecting a violation of any of the one or more preconfigured rules.

3. The apparatus of claim 2, wherein the data capture session further comprises:
upon detecting a violation, communicating a notification through one or more output devices communicatively coupled to the processor.

4. The apparatus of claim 1, wherein the data capture session further comprises activating a means for controlling an ingress, egress, or internal positioning of an object within the apparatus.

5. The apparatus of claim 1, wherein the processor is configured to perform a session initiation and user registration session by executing a further set of instructions stored in the memory, the further set of instructions causing the apparatus to:
detect a weight differential through the one or more sensors;
detect a presence of a custom card, wherein the custom card comprises a user identifier and one or more weights;
retrieve the user identifier from the custom card and calibrate at least one of the one or more sensors through the one or more weights;
generate a session identifier associated with the data capture session; and
associate the user identifier with the session identifier.

6. The apparatus of claim 1, further comprising:
an accelerometer, wherein the processor is further configured to evaluate one or more forces acting on the apparatus around the time of weight measurement to modify the measured weight based on the one or more forces.

7. The apparatus of claim 1, wherein the one or more characteristics comprise gender, size, weight, species, presence of eggs, and molting stage of a marine animal.

8. The apparatus of claim 1, further comprising a mating flange allowing mating of the apparatus to a second apparatus such that the processor is able to communicate instructions to and receive communications from a second processor of the second apparatus.

9. The apparatus of claim 2, wherein upon performing the data capture session, the processor executes a further set of instructions causing the apparatus to:

10. A method of a data capture session through an apparatus, the data capture session comprising:
detecting, through a processor of the apparatus, a weight differential through one or more sensors communicatively coupled to the processor;
measuring a weight and capturing an image through the one or more sensors; and
compare one or more characteristics derived from the image or the weight to one or more preconfigured rules of the processor.

11. The method of claim 10, further comprising detecting a violation of any of the one or more preconfigured rules.

12. The method of claim 11, further comprising:
upon detecting a violation, communicating a notification through one or more output devices communicatively coupled to the processor.

13. The method of claim 10, further comprising activating a means for keeping an object deposited into the apparatus at rest within the apparatus.

14. The method of claim 10, wherein the step of measuring the weight further comprises modifying the weight measurement based on one or more forces detected through an accelerometer of the apparatus.

15. The method of claim 10, wherein the one or more characteristics comprise gender, size, weight, species, presence of eggs, or molting stage of a marine animal.

16. A method of initiating a data capture session of an apparatus, comprising:
detecting, through a processor, a presence of a custom card, wherein the custom card comprises a user identifier and one or more weights;
retrieving the user identifier from the custom card;
validating the user identifier against a whitelist of user identifiers;
calibrating at least one of the one or more sensors through the one or more weights;
generating a session identifier associated with the data capture session; and
associating the user identifier with the session identifier.
